(19) United States
(12) Patent Application Publication
(10) Pub. No.: US 2018/0300769 A1
(43) Pub. Date: Oct. 18, 2018

(54) DISPLAY SPACE PROVISION SYSTEM

(71) Applicants: Nam Gyun KIM, Seoul (KR); Kyong Jun PARK, Seoul (KR)

(72) Inventors: Nam Gyun KIM, Seoul (KR); Kyong Jun PARK, Seoul (KR)

(21) Appl. No.: 15/569,604

(22) PCT Filed: Apr. 28, 2015
(86) PCT No.: PCT/KR2015/004276

§ 371 Date: Oct. 26, 2017

(51) Int. Cl. G06Q 30/02; G06Q 50/00; H04L 29/06

(52) U.S. Cl. CPC G06Q 30/0276; H04L 63/083; G06Q 50/01

(57) ABSTRACT

The present invention relates to a display space provision system. The display space provision system enables a user to access an information provision server by using a user terminal carried by the user and then to display a photo or video created by the user or a photo or video posted on an SNS medium on a display device installed in a specific crowded place (e.g., a tourist spot, a cultural site, a national park, a school, a military camp, a prison, or the like) during a desired amount of time on a desired date and time by paying a predetermined service charge or to hold a special exhibition event by using the photo or the video, enables the user to confirm details of the display by transmitting a shot of the display device displaying the photo or video to the user terminal, and enables the user to access the information provision server and an SNS media server at anywhere at any time to view the photo or video again by storing the photo or the video in an information provision DB and an SNS media DB when the display of the photo or the video ends.

### TECHNICAL FIELD

The present invention relates to a display space provision system, and more particularly, to a display space provision system for enabling a user to display a photo or video created by the user or a photo or video posted on an SNS medium on a specific display device installed at a specific place (e.g., a tourist spot, a cultural site, a national park, a school, a military camp, a wall of a specific building, or the like) for a desired amount of time on a desired date and time or to hold a special event by using the photo or the video, and for notifying a terminal of the user of details of the display through a photo.

### BACKGROUND ART

Social networking services (SNS), which are a services for forming a human network based on participation and sharing by consumers, is attracting attention as new media as the number of users of such social networking services is rapidly increasing worldwide. Recently, social networking services have been diversified and specialized for games, music, business connections, location-based services, advertisements, etc. beyond simple networking-oriented services. As usage and the number of users expands, the advertising market in social networking services is also expanding.

In particular, social networking services are rapidly growing due to the increase in subscribers for Facebook and Twitter. According to eMarketer, the number of global social networking service users is expected to maintain double-digit growth from 1.43 billion users in 2012 to 1.85 billion users in 2014.

With the development of such SNS media, people create photos or videos and upload the created photos or videos to SNS media such as Facebook, Instagram, Kakao Story, YouTube, Twitter, and Naver Line in order to deliver information to many other people and share information with them.

FIG. 1 is a block diagram showing a configuration of a conventional SNS medium 100.

Referring to FIG. 1, the conventional SNS medium 100 generally includes a user terminal 110, a wired/wireless information communication network 120, an SNS media server 130, and an SNS media database (DB) 40.

Generally, a smartphone, a tablet, a notebook, and on the like are used as the user terminal 110.

The SNS media server 130, which is a server for providing social networking services (SNS) such as YouTube, Facebook, Kakao Story, Instagram, Naver Line, or Twitter, is used to enable a user to upload a photo or video by means of the user terminal 110 to the SNS media server 130 to store the photo or video in the SNS media DB 140, share the photo or video with other users, or allow other users to search for the photo or video.

FIG. 2 is a block diagram showing a configuration of a conventional SNS medium in a case where a photo or video is advertised through the conventional SNS medium.

Referring to FIG. 2, when the user advertises the photo or video by using the SNS medium 100 by means of the user terminal 110, a financial payment server 150 capable of paying for the advertisement is added to the SNS medium 100 of FIG. 1.

As shown in FIG. 2, the user may store, share, search for, or advertise the photo or video by using the SNS medium by means of the user terminal 110.

As described above, users upload photos or videos they create to SNS media so that many other people may view the photos or videos. However, much like books in large libraries, if specific keywords are not intentionally entered to search for the photos or videos, the photos or videos cannot be exposed to others. Of course, videos and photos that are popular or well-known through word-of-mouth may be exceptions. However, generally, in order to make photos or videos created by users viewable by many people, a high advertisement cost should be paid for TV broadcasting or SNS media so that the photos or videos may be exposed to many people. Unlike with TV advertisements wherein broadcasting companies and exposure times are fixed, with SNS media, users may check simple exposure-related numbers provided by the SNS media when such exposure is requested at high cost. However, advertisement requests in SNS media have problems in that users cannot exactly check for when, where, and to how many people the advertisements are exposed.

For example, in FIG. 2, a high advertisement cost is required, and even when an advertisement is shown, it is difficult to exactly check when, where, and to how many people the advertisement is exposed by only using exposure-related numbers provided by the SNS media.

When a video letter is delivered from somebody who cannot attend a school entrance ceremony or a school graduation ceremony or when a video letter is delivered to a son or a lover in military service in place of a visit, currently the video letter must be delivered to a personal computer, a smartphone with a narrow screen, or a television.

In order to solve such a problem, there is a need to expand to various mobile platforms. Currently, advertisements using social networks have been very successful in the online advertisement market based on a wired or wireless Internet connection. However, along with the recent widespread usage of mobile communication devices such as smartphones, a transition to mobile advertisement platforms is being made.

Accordingly, there is a need for a technology enabling users to conveniently display photos or videos stored in their mobile communication devices or display photos or videos posted on SNS media on a desired display device installed at a crowded place (e.g., a tourist spot, a cultural site, a national park, a school, a military camp, a prison, a bus terminal, a station, or the like) for a desired time period at a desired time, date, and place at a low cost. In order to provide a mobile advertisement platform, there is also a need for a technology for conveniently notifying the mobile communication device with a shot of the display device displaying the photo or video by using text and photos.

### DETAILED DESCRIPTION OF THE INVENTION

### Technical Problem

The present invention has been made to solve the above-mentioned problems occurring in the related art, and the present invention is directed to providing a display space provision system configured to, at a low cost, hold a special exhibition event or display a photo or video created by a user or a photo or video posted on an SNS medium (e.g., YouTube, Facebook, Instagram, Twitter, Kakao story, and Naver Line) on a screen of a specific display device installed in a crowded place (e.g., a tourist spot, a cultural site, a national park, a station, a bus stop, a school, a military camp, and a prison) according to display conditions (e.g., year, month, day, time, and display duration) selected by the user; notifies the user with a shot of the display device displaying the photo or by using text and a photo; and store the photo or video in an information provision database (DB) and the SNS medium when the display of the photo or video is complete, so that the user may view the photo or video having been displayed and the shot anywhere at any time.

### Technical Solution

In order to achieve the object of the present invention, a display space provision system according to the present invention includes a user terminal used as an input device configured to receive a photo or video created by a user or a uniform resource locator (URL) of a photo or video posted on an SNS medium (e.g., YouTube, Facebook, Instagram, Twitter, Kakao story, and Naver Line) and select display conditions and a display device for displaying the photo or video and also used as a device configured to check whether the photo or video is correctly displayed according to the display conditions selected by the user; a display device installed at a place selected by the user and configured to display the photo or video according to the display conditions selected by the user; an information provision server configured to communicate with the user terminal over a wired/wireless information communication network (e.g., a wired Internet and a wireless Internet), configured to upload the photo or video from the user terminal or copy and input a URL of the SNS medium on which the photo or video is posted, configured to determine, as user display information, a user ID and password of the user and the photo or video or the URL of the SNS medium on which the photo or video is posted, the display device, and the display conditions entered by the user through a photo/video upload input screen, a display device selection screen, and a display condition selection screen when a request to select the display device and the display conditions is received, configured to store the user display information in an information provision DB, and configured to deliver the user information to a display device management server; an information provision DB configured to store the photo or video of the user terminal or the photo or video entered through an input screen of the URL of the SNS medium on which the photo or video is posted, one or more country names, one or more city names, one or more place names, and one or more display devices provided through the display device selection screen, and store the user display information; a display device management server configured to communicate with the display device and the information provision server over a wired/wireless information communication network (e.g., a wired Internet and a wireless Internet) and display the photo or video entered by the user or the photo or video posted on the URL of the SNS medium entered by the user on a screen of the display device selected by the user according to the display conditions selected by the user when the user display information is received from the information provision server; and a financial payment server configured to pay a service charge for the display of the photo or video by the display device management server.

### Advantageous Effects of the Invention

The display space provision system according to the present invention has an advantage in that the display space provision system can display a photo or video created by a user or a photo or video posted on an SNS medium on a display device (e.g., a large multi-monitor display device) installed at his or her desired place on his or her desired date and time for his or her desired period of time in order to share the photo or video with many people at a low cost.

Conventionally, a user cannot check whether a photo or video desired to be advertised is appropriately exposed to many people although he or she pays a high cost to the SNS medium. However, the display space provision system according to the present invention has an advantage in that the user can check for exposure because the display space provision system notifies a user, by means of the user terminal, with a shot of the display device displaying a photo or video desired to be shared with other people.

Also, the display space provision system according to the present invention has an advantage in that a new mobile advertising platform can be established for displaying a user's video letter on a large multi-monitor display installed in a school, a military camp, or a prison at a desired time for a certain time period in order to send the video letter to his or her acquaintance instead of visiting the acquaintance, and also has an advantage in that the display space provision system can be used by a person who inevitably cannot attend a school entrance ceremony or a school graduation ceremony in order to deliver a congratulatory video message or by a person who has a son or a lover in the military to deliver a video letter for giving his family's best regards, instead of visiting him, conveniently at a low cost.

### DESCRIPTION OF THE DRAWINGS

FIG. 1 is a block diagram showing a configuration of a conventional SNS medium.

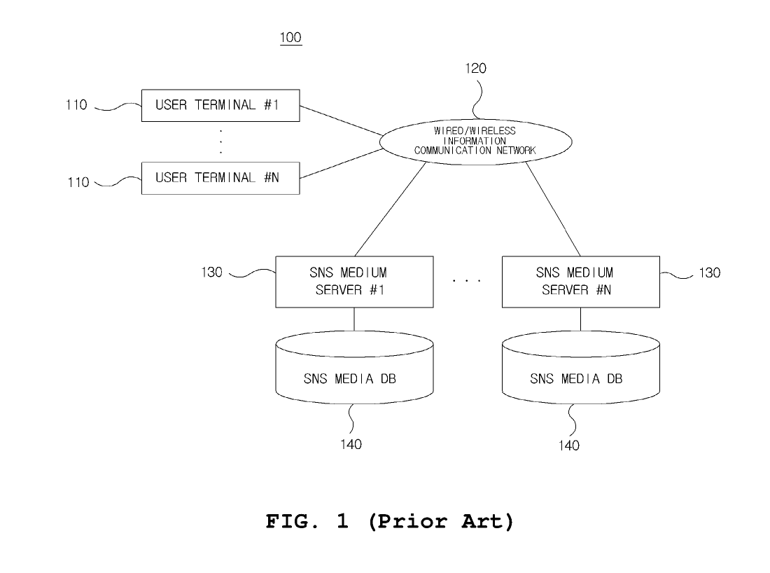

FIG. 2 is a block diagram showing a configuration of a conventional SNS medium in a case where an advertisement is made through the conventional SNS medium.

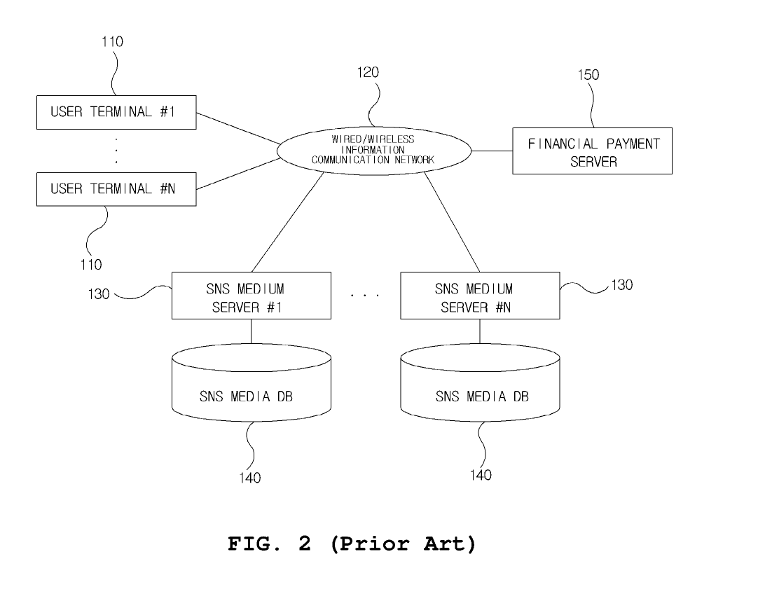

FIG. 3 is a block diagram showing a configuration of a display space provision system according to the present invention.

FIG. 4 is an information flow diagram of a display space provision system according to the present invention.

FIG. 5 shows an example of an initial screen of a display space provision system according to the present invention.

FIG. 6 shows an example of a screen for selecting a country where a display device of the display space provision system according to the present invention is installed.

FIG. 7 shows an example of a screen for selecting a place where a display device of the display space provision system according to the present invention is installed.

FIG. 8 shows an example of a screen for previewing a place where a display device of a display space provision system according to the present invention is installed.

FIG. 9 shows an example of a display condition selection screen of a display space provision system according to the present invention.

FIG. 10 shows an example of a payment screen of a financial payment server of a display space provision system according to the present invention.

FIG. 11 shows an example of a payment completion notification screen using a financial payment server of a display space provision system according to the present invention.

FIG. 12 shows a first example of a photo/video upload input screen of a display space provision system according to the present invention.

FIG. 13 shows a second example of a photo/video upload input screen of a display space provision system according to the present invention.

FIG. 14 shows an example of a photo/video upload completion notification screen of a display space provision system according to the present invention.

FIG. 15 shows an example of a screen for checking whether a photo or video of a display space provision system according to the present invention is correctly displayed.

FIG. 16 shows an example of a screen for notifying with a shot of a display device displaying a photo or video of a display space provision system according to the present invention.

FIG. 17 shows an example of a screen in which a photo or video of a display space provision system according to the present invention is displayed on a display device.

FIG. 18 shows an example of a screen for confirming that a photo or video has been displayed through an SNS medium by using a display space provision system according to the present invention.

### BEST MODE

Hereinafter, preferred embodiments of the present invention will be described in detail with reference to the accompanying drawings.

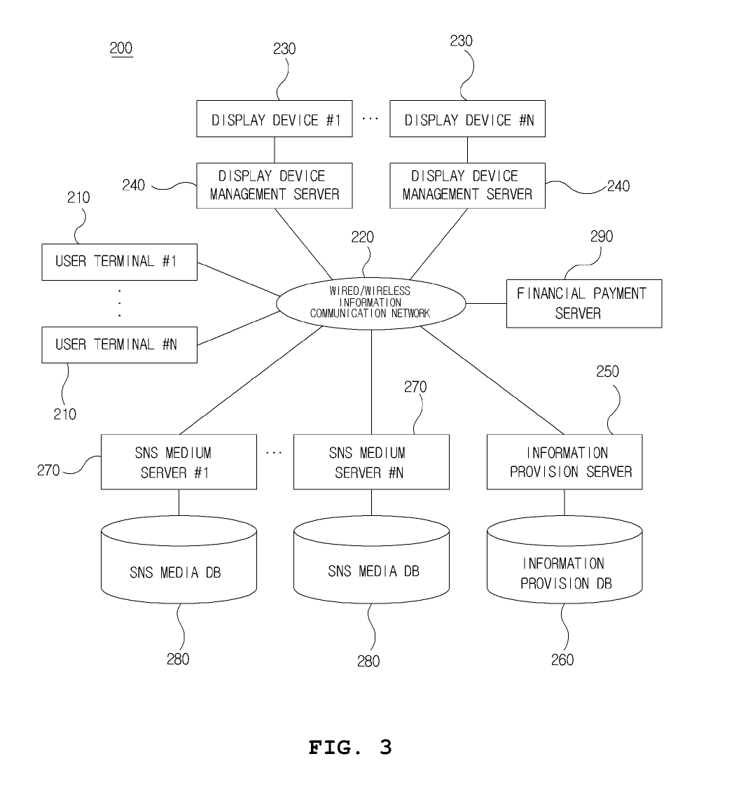

FIG. 3 is a block diagram showing a configuration of a display space provision system 200 according to the present invention.

Referring to FIG. 3, the display space provision system 200 according to the present invention includes a user terminal 210, a wired/wireless information communication network 220, a display device 230, a display device management server 240, an information provision server 250, an information provision database (DB) 260, an SNS media server 270, an SNS media DB 280, and a financial payment server 290.

The user terminal 210, the display device management server 240, the information provision server 250, the SNS media server 270, and the financial payment server 290 may perform communication over the wired/wireless information communication network 220 (e.g., wired Internet, wireless Internet, etc.).

The user terminal 210 is used as a device for enabling a user to upload and input a photo or video desired to be displayed on the display device 230, preview and select a background image of a place where the display device 230 on which the photo or video is displayed is installed, select display conditions (e.g., year, month, day, hour, and display duration) for displaying the photo or video, pay a service charge, and receive and check a photo including a shot of the display device 230 displaying the photo or the video.

The user terminal 210 may be a mobile communication device (e.g., a smartphone, a smart watch, a tablet, iPhone, iPad, iWatch, a notebook, etc.), a personal computer, or an unmanned information terminal (KIOSK).

The display device 230 is installed at a crowded place selected by the user (e.g., a tourist spot, a cultural site, a national park, a station, a bus stop, a school, a military camp, a prison, or the like) and configured to display the photo or video on a screen according to display conditions selected by the user.

It is preferable to use a large multi-monitor display as the display device 230. The display device 230 may be configured as one large monitor or a combination of smaller monitors which may be a commercially sold LCD, LED, OLED, or PDP type. The display device 230 may be installed at any indoor or outdoor place with an internal or external camera, a speaker, a memory, a wired/wireless Internet communication device, a constant temperature and humidity control device, a personal computer, or the like being attached to the display device 230.

The display device management server 240 may transmit or receive information to or from the display device 230 and the information provision server 250 over the wired/wireless information communication network 220. When user display information is received from the information provision server 250, the display device management server 240 enables the user to correctly display a photo or video input by the user on a screen of the display device 230 selected by the user according to display conditions selected by the user.

The information provision server 250 may transmit or receive information to or from the user terminal 210 over the wired/wireless information communication network (e.g., wired Internet, wireless Internet, etc.).

The information provision server 250 is configured to enable the user to enter the photo or video stored in the user terminal 210 by means of the user terminal 210, enable the user to select display conditions (e.g., year, month, day, hour, and display duration) and the display device 230 by providing a display condition selection screen and a display device selection screen, and enable the user to pay a service charge through the financial payment server 290. Also, the information provision server 250 is configured to determine, as user display information, the display conditions and the display device 230 selected by the user in addition to a login ID and a password of the user and store the user display information in the information provision DB 260.

The information provision server 250 is configured to enable the user to enter a uniform resource locator (URL) of the photo or video posted on an SNS medium by means of the user terminal 210, enable the user to select display conditions (e.g., year, month, day, hour, and display duration) and the display device 230 by providing a display condition selection screen and a display device selection screen, and enable the user to pay a service charge through the financial payment server 290. Also, the information provision server 250 is configured to request information corresponding to the URL of the photo or video from the SNS media server 270 requested by the user to be displayed, receive a photo or video corresponding to the URL and stored in the SNS media DB 280 from the SNS media server 270, determine the display conditions and the display device 230 selected by the user in addition to a login ID and a password of the user as user display information, and store the user display information in the information provision DB 260.

The information provision server 250 is configured to determine the photo or video stored in the information provision DB 260, the display conditions and the display device selected by the user, and the login ID and password of the user as user display information and transmit the user display information to the display device management server 240. Also, when a request is received from the user terminal 210 to check whether the photo or video desired by the user to be displayed is correctly displayed on the display device 230, the information provision server 250 is configured to transmit a photo including a shot of the display device 230 displaying the photo or video. Also, the information provision server 250 is configured to categorize and store a photo or video having been displayed on the display device 230 by country, city, location, date, etc. under an account of the information provision server 250 registered in the SNS media server 270 and the information provision DB 260, thus enabling the user to view the photo or video again anywhere at any time.

When a plurality of display devices 230 are installed at a place selected by the user, the information provision server 250 enables the user to select a display device 230 located at his or her desired place among the plurality of display devices 230 through the display device selection screen.

An input screen for uploading a photo or video to the user terminal 210 may be variously configured to directly upload the photo or video stored in the user terminal 210 or input a URL of the photo or video posted on the SNS medium.

The display device selection screen may be variously configured in any form to search for a place by country or city and search for and select a display device 230 installed in the place or to search for and select the display device 230 installed in a corresponding place through a place search regardless of country or city.

The display condition selection screen may be variously configured in any form as long as one or more of year, month, day, and display duration are provided and selected.

The information provision DB 260 stores a photo, video, or URL entered through the input screen of the user terminal 210, one or more country names, one or more city names, one or more place names, and one or more display devices 230 provided through the display device selection screen, and stores display conditions and a login ID and password of a user provided through the display condition selection screen.

The SNS media server 270 is used to enable the user to search for the photo or video stored in the SNS media DB 280 by using a URL of a photo or video entered by the user.

The SNS media server 270, which is a server for providing social networking services (SNS) such as YouTube, Facebook, Kakao Story, Instagram, Naver Line, or Twitter, is used to enable the user to upload a photo or video to the SNS media server 130 by means of the user terminal 210 to store the photo or video in the SNS media DB 140, share the photo or video with other users, or allow other users to search for the photo or video.

The financial payment server 290, which is a server needed by the user to use a photo or video display service provided by the display device management server 240 and then pay for the service, may be readily understood by those skilled in the art and implemented in various ways although technology for personal authentication using personal financial transaction authentication or the like and technology for interworking with a financial payment server operated by a financial institution to provide paid services are not described herein.

The display provision system 200 having the above-described configuration according to the present invention may be implemented in various ways as follows.

According to the present invention, a user may access the information provision server 250 and receive a display space provision service according to the present invention by means of the user terminal 210.

According to the present invention, a user may access the information provision server 250 and use a display space provision service by means of a user terminal 210 equipped with an application for operating the display space provision service.

According to the present invention, by the user accessing the information provision server 250 by means of the user terminal 210 to directly upload a photo or video or enter a URL of a photo or video posted on an SNS medium to be displayed on a display device 230 installed at a place he or she is visiting for the purpose of love, friendship, promotion, or advertisement and then select display conditions, it is possible to display the photo or video on the display device 230. In this case, the user may commemorate his or her love or friendship or perform promotion and advertisement while viewing a photo or video displayed at the place he or she is visiting according to the selected display conditions.

In a different case, by the user accessing the information provision server 250 by means of the user terminal 210 to enter a photo or video to be displayed on a display device 230 installed at a place he or she has visited in the past and then select display conditions, it is possible to display the photo or video on the display device 230 for the purpose of love, friendship, promotion, or advertisement. In this case, the user may recall and commemorate his or her love or friendship or perform promotion and advertisement through the photo or video displayed at the place he or she has visited according to the selected display conditions.

In a different case, by the user accessing the information provision server 250 by means of the user terminal 210 to enter a photo or video to be displayed on a display device 230 installed at a place he or she has not yet visited but will visit someday in the future and then select display conditions, it is possible to display the photo or video on the display device 230 for the purpose of his or her love, friendship, promotion, or advertisement. In this case, upon visiting the place, the user may recall and commemorate his or her love or friendship or perform promotion and advertisement while viewing the photo or video displayed according to predetermined display conditions.

In a different case, by the user accessing the information provision server 250 by means of the user terminal 210 to enter a photo or video to be displayed on a display device 230 installed at a place he or she has not visited but is scheduled to visit someday in the future and then select display conditions, it is possible to display the photo or video on the display device 230 for the purpose of love, friendship, promotion, or advertisement. In this case, upon visiting the place at the scheduled time, the user may recall and commemorate his or her love or friendship or perform promotion and advertisement while viewing the photo or video displayed at the place according to predetermined display conditions.

In a different case, by the user accessing the information provision server 250 by means of the user terminal 210 to enter a photo or video of a product to be displayed on a display device 230 determined to be installed at a crowded place the user will not visit and then select display conditions, it is possible to display the photo or video of the product to achieve customized advertisement for the purpose of promotion or advertisement of the product.

An information flow of the display space provision system 200 implemented in various ways according to the present invention will be described below in detail, as follows.

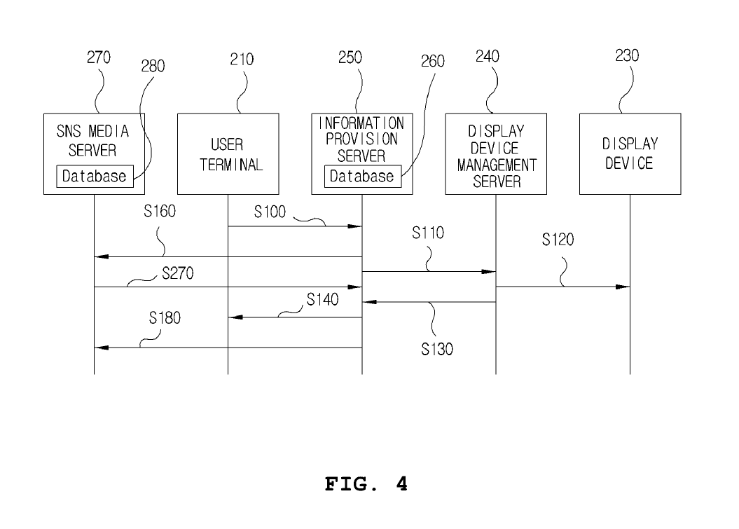

FIG. 4 is an information flow diagram of the display space provision system 200 according to the present invention.

Referring to FIG. 4, a user may access the information provision server 250 by means of the user terminal 210, select display conditions and the display device 230 to be displayed first, pay a service charge, and upload a photo or video stored in the user terminal 210 (S100). The information provision server 250 then determines the display conditions and the display device 230 selected by the user, the uploaded photo or video, and a login ID and password of the user, which are stored in the information provision DB 260, as user display information, transmits the user display information to the display device management server 240, and requests the display device 230 to display the photo or video (S110). The display device management server 240 displays the photo or video on the display device 230 according to the user display information (S120). The information provision server 250 receives a shot of the display device 230 displaying the photo or video desired by the user from the display device management server 240 (S130) and transmits a photo including the received shot to the user terminal 210 (S140).

In a different case, a user may upload a photo or video posted on an SNS medium. In this case, when the user selects display conditions and a display device 230 to be displayed, pays a service charge, and then enters a URL of the photo or video posted on the SNS medium (S100), the information provision server 250 requests the SNS media server 270 to transmit a photo or video corresponding to the URL entered by the user (S160). The SNS media server 270 searches the SNS media DB 280 for the photo or video corresponding to the URL and transmits the photo or video to the information provision server 250 (S170). The information provision server 250 determines the display conditions and the display device 230 selected by the user, the received photo or video, and a login ID and password of the user, which are stored in the information provision DB 260, as user display information, transmits the user display information to the display device management server 240, and requests the display device 230 to display the photo or video (S110). The display device management server 240 displays the photo or video on the display device 230 according to the user display information (S120). The information provision server 250 receives a shot of the display device 230 displaying the photo or video desired by the user from the display device management server 240 (S130) and transmits a photo including the received shot to the user terminal 210 (S140). Also, the information provision server 250 categorizes and stores the photo or video having been displayed by country, city, location, date, etc. under an account of the information provision server 250 registered in the SNS media server 270 and the information provision DB 260, thus enabling the user to search for and find the photo or video anywhere at any time (S180).

A process of accessing the information provision server 250 by means of the user terminal 210, selecting display conditions (e.g., year, month, day, hour, and display duration) and a display device 230, paying a service charge, uploading the photo or video, and displaying the uploaded photo or video on the display device 230 and a process of notifying the user terminal 210 with a photo including a shot of the selected display device 230 displaying the photo or video will be described in detail below through an embodiment of the present invention.

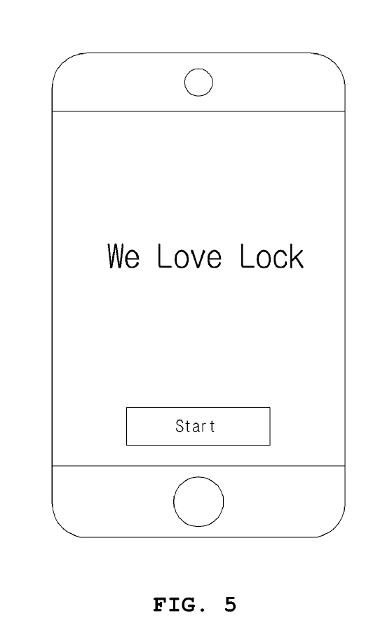

When a user accesses the information provision server 250 by means of the user terminal 210, the information provision server 250 provides an initial screen as shown in FIG. 5.

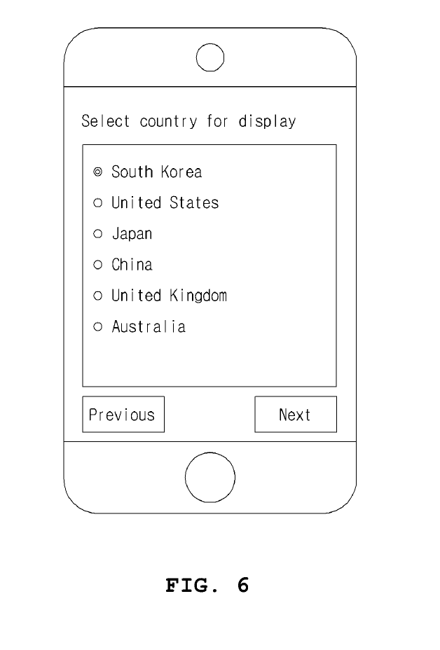

FIG. 5 shows an example of the initial screen of the display space provision system 200 according to the present invention. In this case, the phrase “We Love Lock” and Start button are shown. When Start button is selected, a screen for selecting a country where the display device 230, which will display a photo or video, is located is provided as shown in FIG. 6.

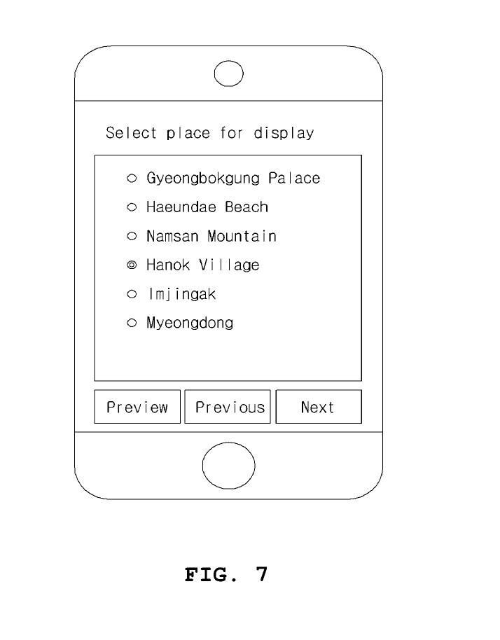

FIG. 6 shows an example of selecting a country where the display device 230 of the display device selection screen of the display space provision system 200 according to the present invention is installed. In this case, it is shown that South Korea is selected when the user selects one of several countries provided for the user to select a country where a photo or video is desired to be displayed. When Next button is selected after the country is selected, a screen for selecting a place where the photo or video will be displayed is provided as shown in FIG. 7. When Previous button is selected, the initial screen (e.g., see FIG. 5) of the display space provision system 200 is provided.

FIG. 7 shows an example of selecting a place where the display device of the display device selection screen of the display space provision system 200 according to the present invention is installed. In this case, it is shown that Hanok Village has been selected by the user as a place for display. When Preview button is selected in FIG. 7, the user can preview the display device installed in the place for display and its background image. Also, when Previous button is selected, a screen for selecting a country where the display device 230 is installed (e.g., see FIG. 6) returns. Also, when Next button is selected, the display device 230 installed in the selected place is provided in addition to the background image.

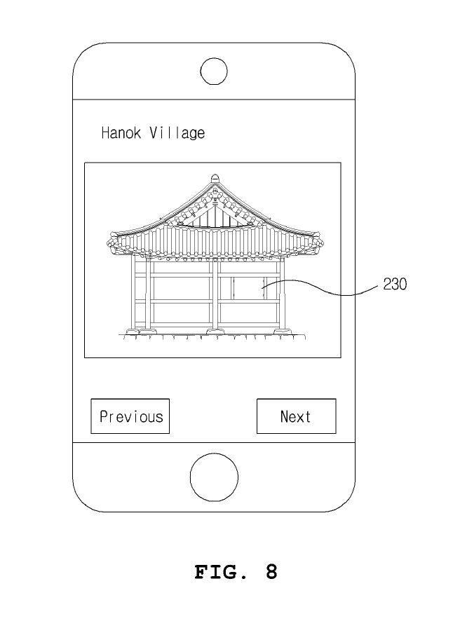

FIG. 8 shows an example of a screen for previewing a place where the display device 230 of the display device selection screen of the display space provision system 200 according to the present invention is installed. In this case, a display device 230 installed in Hanok Village is shown as a result screen obtained by selecting Preview button in FIG. 7. When the user thinks the selected place for display is satisfactory, he or she may select Next button to go to the display condition selection screen. When the user wants to select another place, he or she may select Previous button to go back to the display device selection screen.

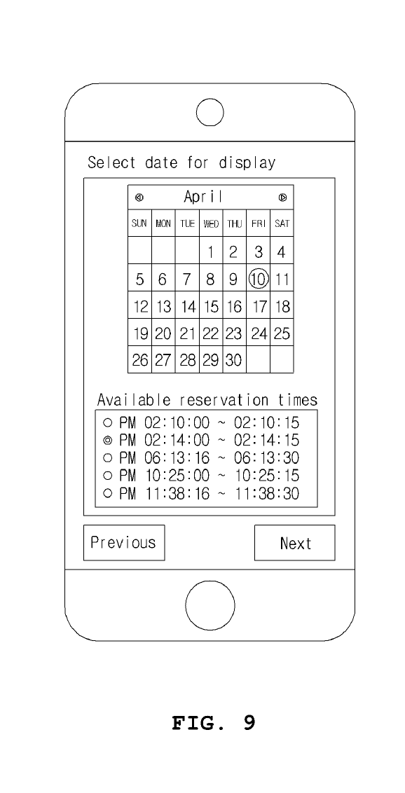

FIG. 9 shows an example of the display condition selection screen of the display space provision system 200 according to the present invention. In this case, the user touches a date for display on the display condition selection screen provided in the form of a calendar to select the date, and touches a time for display upon selection of a time period to select a display time. In this embodiment, it is shown that 2:14 pm on April 10 has been selected. When it is determined that the selected date and time is satisfactory, the user selects Next button to go to a payment screen. When Previous button is selected in FIG. 9, the user goes back to the screen for viewing the selected place for display.

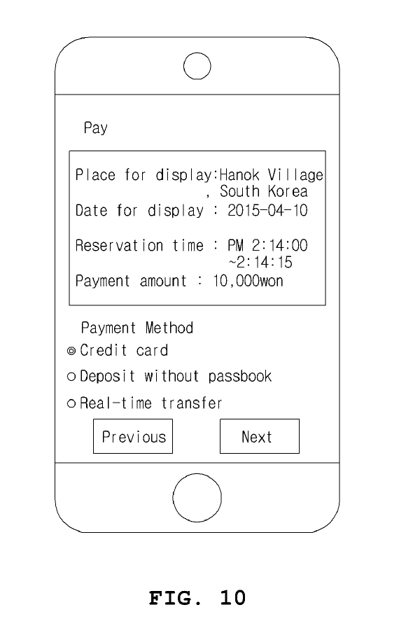

FIG. 10 shows an example of a payment screen of the display space provision system 200 according to the present invention. The place for display, date for display, reservation time, payment amount, and payment method selected by the user are provided for the user. In this embodiment, it is shown that the place for display is Hanok Village in South Korea, the date for display is April 10 in 2015, the reservation time ranges from 2:14:00 pm to 2:14:15 pm, and the payment amount for a service charge is 10,000 won. When the user wants to make a payment, he or she should select a payment method and then select Pay button. When the user wants to select another date and time, he or she should select Previous button. The payment can be made by using a method that is commonly used online such as credit card payment and mobile phone payment, and thus a description with reference to a drawing showing the payment screen will be omitted in this embodiment.

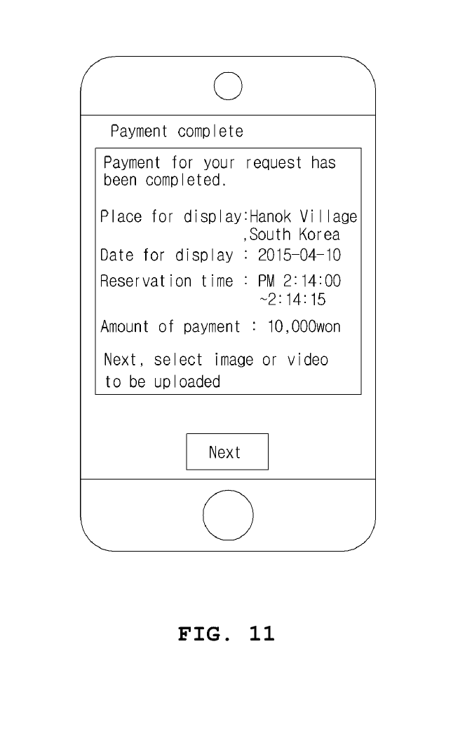

FIG. 11 shows an example of a payment completion notification screen using the financial payment server 290 of the display space provision system 200 according to the present invention. When a user confirms a place for display, a date for display, a reservation time, and a payment amount and selects Pay button on the payment screen of FIG. 10, he or she receives a notification that payment has been completed. After confirming that the payment completion notification has been received, the user selects Next button and enters a photo or video desired to be displayed.

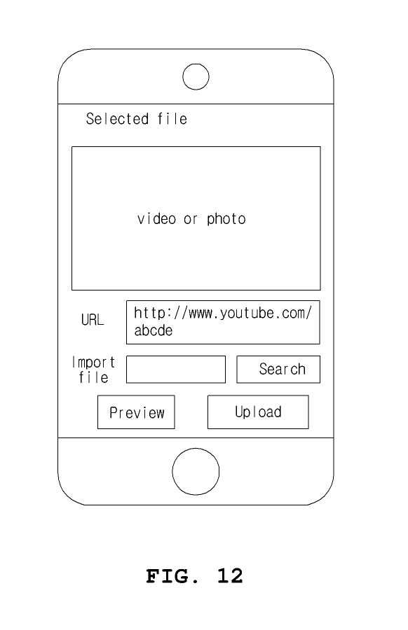

FIG. 12 shows a first example of a photo/video upload input screen of the display space provision system 200 according to the present invention. The photo/video upload input screen is an upload screen using a URL of a photo or video already displayed on an SNS medium. In this embodiment, the user accesses YouTube (https://www.youtube.com), which is the SNS media server 270, and copies and enters a URL (https://www.youtube.com/abcde) of his or her desired photo or video. When the user selects Preview button to check whether a photo or video of the URL entered by the user is correct, the photo or video corresponding to the URL entered by the user is shown, and thus the user may confirm that a selected file is correct. When the selected file is corrected, the user selects Upload button to enter the photo or video.

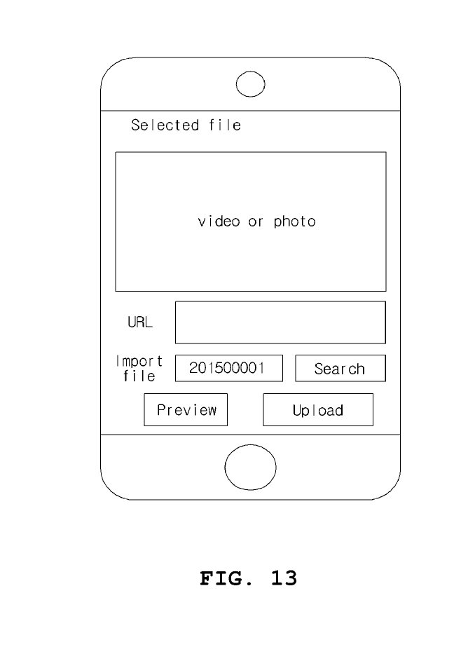

FIG. 13 shows a second example of a photo/video upload input screen of the display space provision system 200 according to the present invention. The photo/video upload input screen is a screen for the user to upload the photo or video stored in the user terminal 210. In order to upload the photo or video stored in the user terminal 210, the user may select Find button to select a photo or video to be uploaded. File selection may be performed in the same way as that of a typical file upload, and thus a detailed description thereof will be omitted. In this embodiment, it can be seen that the user has selected and loaded a file “20150001,” which is a photo stored in the user terminal 210. The user selects Previous button and makes a confirmation in the way that has been described with reference to FIG. 12, selects Upload button, and enters the photo or video.

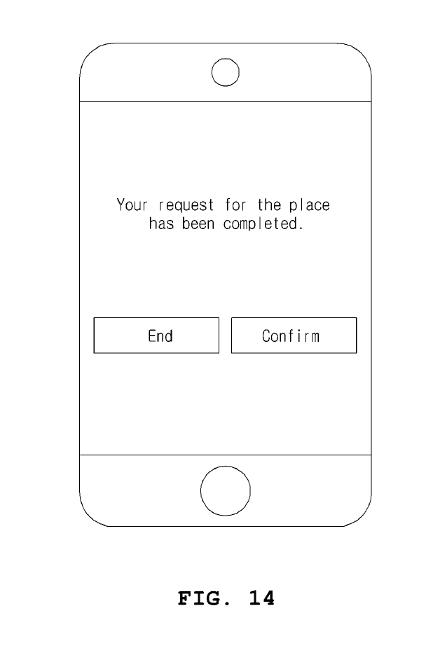

FIG. 14 shows an example of a photo/video upload completion notification screen of the display space provision system 200 according to the present invention. When Upload button is selected in FIGS. 12 and 13, the user terminal 210 is notified with a message that the user's request has been completed. When the user confirms that the request has been completed and wants to end the program, he or she may select End button. In order to check whether the selected country, place, date, and time are accurately displayed, the user may select Confirm button.

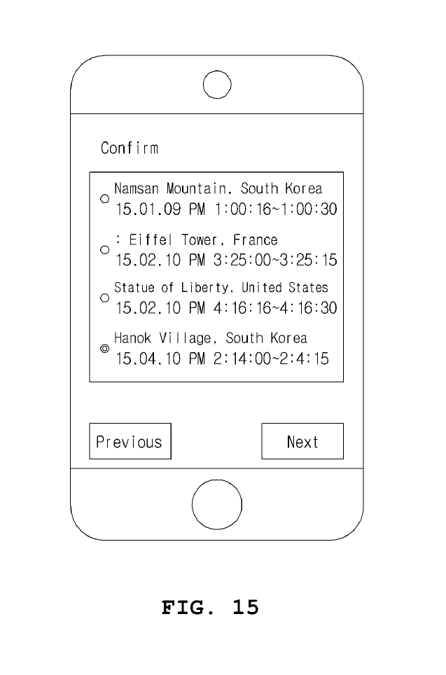

FIG. 15 shows an example of a screen for checking whether a photo or video is correctly displayed on the display device 230 of the display space provision system 200 according to the present invention. The screen is provided when Confirm button is selected in FIG. 14. In this embodiment, it is shown that Hanok Village in South Korea and 2:14:00 pm to 2:14:15 pm on April 10 in 2015 are selected. When Next button is selected, the information provision server 250 notifies the user with a photo including a shot of the photo or video being displayed according to the selected display conditions. When the user does not want to make a confirmation, he or she may select Previous button to go back to the upload completion notification screen (e.g., see FIG. 14) and end the program.

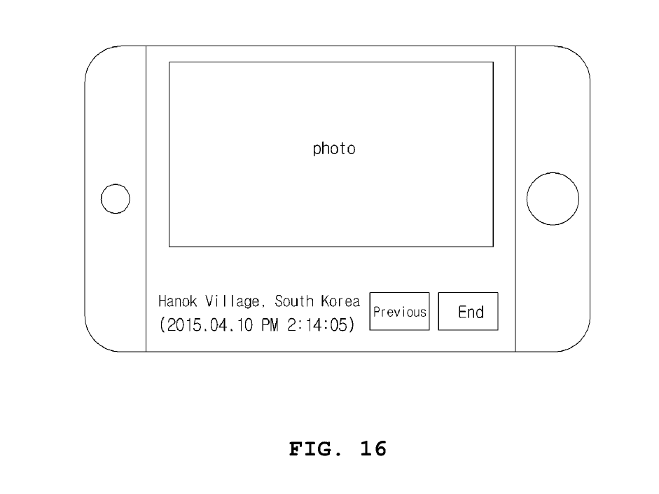

FIG. 16 shows an example of a screen for notifying the user terminal 210 with a shot of the display device 230 displaying the photo or video of the display space provision system 200 according to the present invention. It may be confirmed that the display is performed at a time and place selected by the user, that is, in Hanok Village, South Korea at 2:14:05 pm on Apr. 10, 2015 by selecting Next button. When the user wants to view a display completion shot for another place, he or she may select Previous button to select the place from the confirmation list of FIG. 15. When the user wants to end after confirming the shot, he or she may select End button of FIG. 16 and end the program.

The display device 230 of the display space provision system 200 according to the present invention may be installed in various places to display the photo or video.

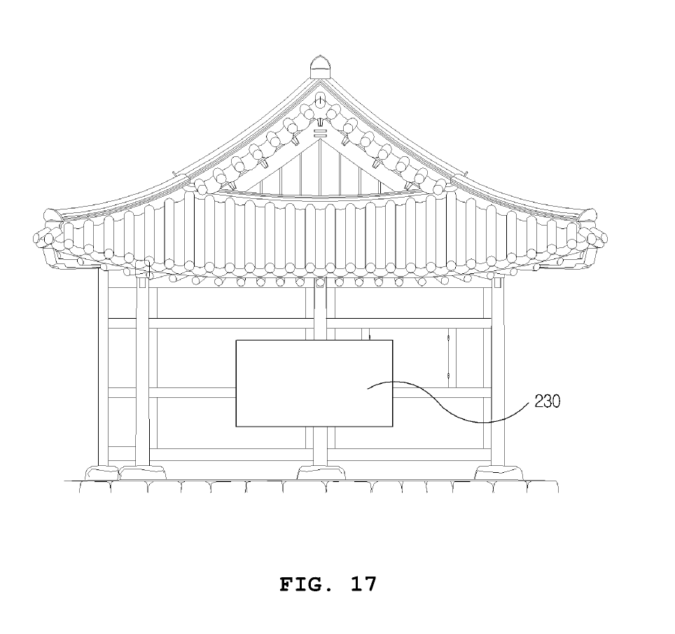

FIG. 17 shows an example in which a photo or video is displayed on a display device 230 installed on an outer wall of a Hanok building and utilized for a promotion, advertisement, or special exhibition event.

In a different case, the display device 230 may be installed in a separate structure.

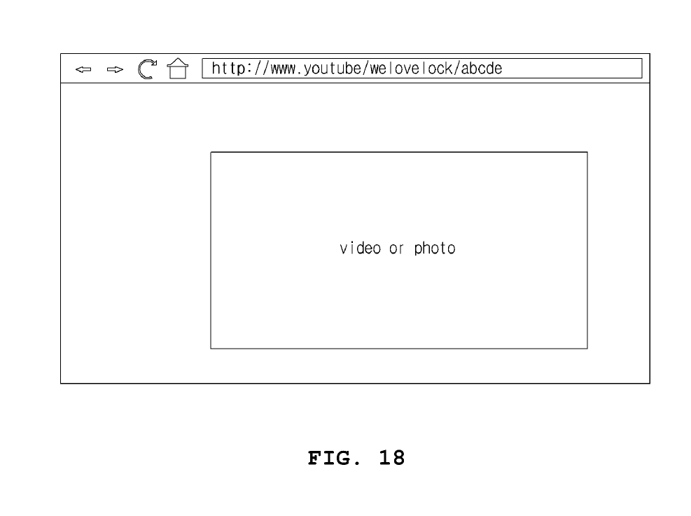

FIG. 18 shows an example of a screen for confirming a photo or video having been displayed through an SNS media DB 280 by using a display space provision system 200 according to the present invention. In this embodiment, display of a photo or video stored in YouTube, which is a kind of SNS medium, is confirmed. It can be seen that a URL corresponding to the photo or video is displayed. A photo or video having been displayed and having a file name “abcde” is shown in a lower category of an account (https://www.youtube.com/welovelock” of the information provision server 250 registered on YouTube.

The display space provision system 200 according to the present invention has an advantage in that the display space provision system 200 can display a photo or video created by a user or a photo or video posted on an SNS medium on a display device (e.g., a large multi-monitor) installed at his or her desired place at his or her desired date and time for his or her desired period of time in order to share the photo or video with many people at a low cost.

Also, conventionally, a user cannot check whether a photo or video desired to be advertised is appropriately exposed to many people although he or she pays a high cost to the SNS medium. However, the display space provision system 200 according to the present invention has an advantage in that the user can check for exposure because the display space provision system 200 notifies a user, by means of the user terminal 210, with a shot of the desired display device displaying a photo or video desired to be shared with other people.

Also, the display space provision system 200 according to the present invention has an advantage in that a new mobile advertising platform can be established for displaying a user's video letter on a large multi-monitor installed in a school, a military camp, or a prison at a desired time for a certain time period to deliver the video letter to his or her acquaintance instead of visiting the acquaintance, and also has an advantage in that the display space provision system 200 can be used by a person who inevitably cannot attend a school entrance ceremony or a school graduation ceremony to deliver a congratulatory video message or by a person who has a son or a lover in the military to deliver a video letter giving his family's best regards, instead of visiting him, conveniently at a low cost.

The aforementioned display space provision system according to the present invention is not limited to the above embodiments. It will be understood by those skilled in the art that various changes in form and details may be made therein without departing from the spirit and scope of the invention as defined in the appended claims.

What is claimed is:

1. A display space provision service system comprising:
a user terminal used as an input device configured to receive a photo or video stored therein or a uniform resource locator (URL) of a photo or video posted on a Social networking service (SNS) medium, select a display device on which the stored photo or video or the photo or video posted on the SNS medium is desired to be displayed, select display conditions in which the photo or video is desired to be displayed on the display device, confirm a shot of the display device displaying the photo or video, and pay a service charge to display the photo or video on the display device;
a display device installed at a place selected by a user and configured to display the photo or video on a screen thereof according to the display conditions selected by the user;
an information provision server configured to,
communicate with the user terminal over a wired/wireless information communication network,
determine, as user display information, a user ID and password of the user and a photo or video provided to the user terminal or a URL of a photo or video posted on the SNS medium, a display device, and display conditions entered by the user through a screen for entering the photo or video or the URL of the photo or video posted on the SNS medium, a display device selection screen, and a display condition selection screen, which are provided by the user terminal, when a request to select the photo or video, the display device, and the display conditions is received from the user terminal,
store the user display information in an information provision database (DB) and deliver the user information to a display device management server,
receive a shot of the display device displaying the photo or video from the display device management server and transmit the shot to the user terminal when a request is received from the user terminal to check whether the photo or video desired to be displayed by the user is being correctly displayed on the display device, and
categorize and store the photo or video having been displayed by country, city, place, and date under an account of the information provision server registered in the information provision DB or an SNS media server so that the user may find and review the photo or video having been displayed anywhere at any time;
an information provision DB configured to store the user display information and one or more country names, one or more city names, one or more place names, and one or more display devices provided through the display device selection screen;
a display device management server configured to communicate with the display device and the information provision server over a wired/wireless information communication network and display the photo or video entered by the user on the screen of the display device selected by the user according to the display conditions selected by the user when the user display information is received from the information provision server; and
a financial payment server used to pay a service charge for the display of the photo or video by the display device management server.

2. The display space provision service system of claim 1, wherein the user terminal is any one of a mobile communication device, a personal computer, and an unmanned information terminal (KIOSK).

3. The display space provision service system of claim 1, wherein the photo/video input screen is used to directly upload and input the photo or video stored in the user terminal or to input the URL of the photo or video posted on the SNS medium.

4. The display space provision service system of claim 1, wherein the display devices are capable of being installed in any space, but are particularly installed at crowded places such as a tourist spot, a cultural site, a national park, a school, a military camp, a prison, a bus terminal, a train station, and a subway station.

5. The display space provision service system of claim 1, wherein the display device selection screen allows the user to search for a place by country or city and search for and select a display device installed in that place or allows the user to search for a place and select a display device installed in the corresponding place through a place search regardless of country or city.

6. The display space provision service system of claim 1, wherein the display condition selection screen allows the user to select one or more of a display year, a display month, a display day of week, a display time, and a display duration.

7. The display space provision service system of claim 1, wherein the service charge payment is made by using a mobile payment system.

8. The display space provision service system of claim 1, wherein when a plurality of display devices are installed at the place selected by the user, the information provision server allows the user to select a display device located at a favorite place of the user among the plurality of display devices through the display device selection screen.

9. The display space provision service system of claim 1, wherein the information provision server provides a function of displaying the display device and surroundings of the display device on the display device selection screen together, thus enabling the user to select the display device while checking the surroundings of the display device.

10. The display space provision service system of claim 1, wherein the SNS medium is any one of YouTube, Facebook, Kakao Story, Instagram, Naver Line, and Twitter.

11. The display space provision service system of claim 1, wherein the display device is installed at a school and utilized to display a congratulatory message sent by an acquaintance or family members who cannot attend an entrance ceremony or a graduation ceremony and utilized to display a club or department video to remotely send congratulations or introduce a club or a department.

12. The display space provision service system of claim 1, wherein the display device is installed at a military camp or a prison and utilized to display a video for delivering a greeting message on the display device instead of visiting a person who lives in the military camp or the prison when a lover or family members of the person cannot visit the person.
